(19) United States
(12) Patent Application Publication
(10) Pub. No.: US 2008/0201947 A1
(43) Pub. Date: Aug. 28, 2008

(54) Method For Repairing Turbo Machine Blades

(76) Inventors: Karl-Hermann Richter, Markt Indersdorf (DE); Michael Weiss, Dachau (DE)

Correspondence Address: KENYON & KENYON LLP, ONE BROADWAY, NEW YORK, NY, 10004, US

(21) Appl. No.: 11/662,118

(22) PCT Filed: Aug. 26, 2005
(86) PCT No.: PCT/DE05/01501

§ 371 Date: Dec. 20, 2007

(30) Foreign Application Priority Data
Sep. 4, 2004 (DE) 10 2004 042 878.6

(51) Int. Cl. B23P 6/00

(52) U.S. Cl. 29/889.1; 219/121.64

(57) ABSTRACT

A method is for repairing turbo machine blades, e.g., gas turbine blades on integrally bladed gas turbine rotors. The method includes at least the following steps: a) providing a turbo machine blade to be repaired or an integrally bladed rotor to be repaired having a damaged blade section; b) removing the damaged blade section from the turbo machine blade or from the integrally bladed rotor resulting in a blade stump; c) clamping the blade stump at least in the region of a flow leading edge and a flow trailing edge of the same in a cooling device; d) applying respectively a punctiform welding bead in the region of the flow leading edge and a flow trailing edge of the blade stump by laser powder build-up welding, the welding beads protruding at least over the flow leading edge and the flow trailing edge; e) applying material by laser powder build-up welding between the welding beads in the region of the or each removed blade section for restoring the respective blade section.

### FIELD OF THE INVENTION

The present invention relates to a method for repairing turbo machine blades, e.g., gas turbine blades on integrally bladed gas turbine rotors.

### BACKGROUND INFORMATION

In operation, gas turbine blades are subject to wear in particular by oxidation, corrosion and erosion as well as by bird impact or even hail impact. Due to the above-mentioned wear of the gas turbine blades, it may become necessary to repair these after they are damaged by removing damaged sections or regions of the gas turbine blades and to restore the damaged sections or regions after removing them. This is particularly true of repairing gas turbine blades of integrally bladed gas turbine rotors, so-called blisks (bladed disks) or blings (bladed rings).

U.S. Pat. No. 6,172,327 describes a method for repairing gas turbine blades on integrally bladed gas turbine rotors. According to the method, a damaged section of a gas turbine rotor is removed from the integrally bladed gas turbine rotor and subsequently the removed section or region is restored by laser powder build-up welding. Problematic in the method described in U.S. Pat. No. 6,172,327 is particularly the application of the first powder layer by laser powder build-up welding onto the blade stump left behind following the removal of the damaged region. To date no method is known from the related art, which makes allowance for the bonding of the first, particularly critical powder layer.

### SUMMARY

Example embodiments of the present invention provide a method for repairing turbo machine blades, e.g., of gas turbine components of integrally bladed gas turbine rotors.

The method may include at least the following steps: a) providing a turbo machine blade to be repaired or an integrally bladed rotor to be repaired having a damaged blade section; b) removing the damaged blade section from the turbo machine blade or from the integrally bladed rotor, resulting in a blade stump; c) clamping the blade stump at least in the region of a flow leading edge and a flow trailing edge of the same in a cooling device; d) applying respectively a punctiform welding bead in the region of the flow leading edge and the flow trailing edge of the blade stump by laser powder build-up welding, the welding beads protruding at least over the flow leading edge and the flow trailing edge; e) applying material by laser powder build-up welding between the welding beads in the region of the or each removed blade section for restoring the respective blade section.

The blade stump remaining following the removal of the damaged blade section may be clamped in a cooling device at least in the region of the flow leading edge and the flow trailing edge and subsequently to use laser powder build-up welding to apply welding beads extending across and protruding from the flow leading edge and the flow trailing edge. This may provide a perfect bonding of the first critical powder layer when restoring the separated blade section. The cooling in the region of the flow leading edge and the flow trailing edge prevents thermal damage to the blade on these edges, which are particularly thin and therefore particularly vulnerable. The application of the welding points so to speak bridges the distance or clearance between the cooling device and the flow leading edge and the flow trailing edge of the blade stump such that in the subsequent restoration of the severed region the laser powder build-up welding may be performed with an allowance in the region of the flow leading edge and the flow trailing edge. This makes it possible, following the laser powder build-up welding, to provide precise final contour flow leading edges and flow trailing edges by a removal process. The method further allows for a layer build-up that is nearly free of internal stress such that expensive post-heat treatment steps, e.g., stress relief annealing, may normally be omitted.

Exemplary embodiments of the present invention are explained in more detail below with reference to the appended Figures.

### BRIEF DESCRIPTION OF THE DRAWINGS

FIG. 1 illustrates a cooling device that may be used in the method according to example embodiments of the present invention.

FIG. 2 schematically illustrates the region of detail II of FIG. 1 for the purpose of illustrating the method according to example embodiments of the present invention.

FIG. 3 schematically illustrates the region of detail II of FIG. 1 for the purpose of illustrating the method according to example embodiments of the present invention.

### DETAILED DESCRIPTION

The method according to example embodiments of the present invention serve, e.g., for repairing damaged gas turbine blades on integrally bladed gas turbine rotors, so-called blisks or blings. It may also be used, however, for repairing other blades of turbo machines. The damage to the blades may occur either in operation, for example, by a foreign body impact, or in the manufacture of new parts. In the following, the method is described with reference to the repair of a blade of an integrally bladed gas turbine rotor.

In a first step, an integrally bladed gas turbine rotor is provided having a gas turbine blade to be repaired. From the gas turbine blade that is to be repaired from the integrally bladed gas turbine rotor, a damaged blade section then is severed or removed, a so-called blade stump remaining after severing the damaged section.

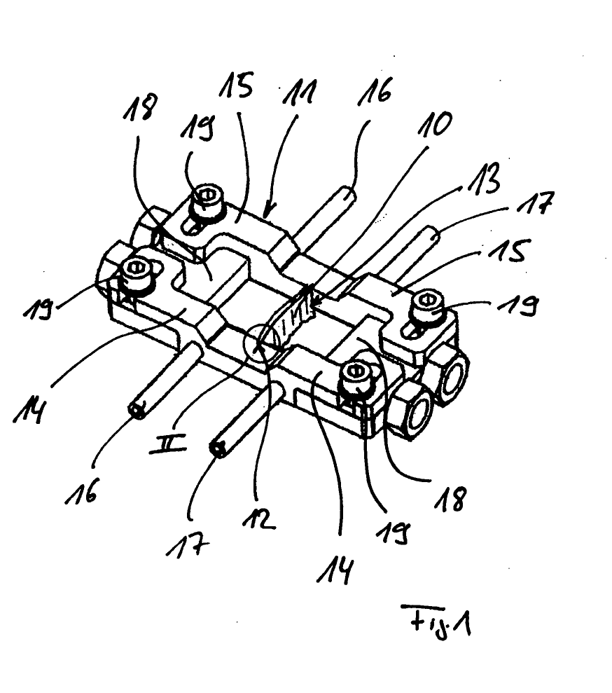

Such a blade stump 10 (see FIG. 1) is positioned in a cooling device 11, blade stump 10 being clamped in cooling device 11 on the one hand in the region of a flow leading edge 12 as well as on the other hand in the region of a flow trailing edge 13. As illustrated in FIG. 1, cooling device 11 is formed by two cooling jaws 14 and 15, each of the two cooling jaws 14 and 15 having a supply line 16 as well as a drainage line 17 for a cooling medium. For cooling, accordingly, a cooling medium flows through cooling jaws 14 and 15.

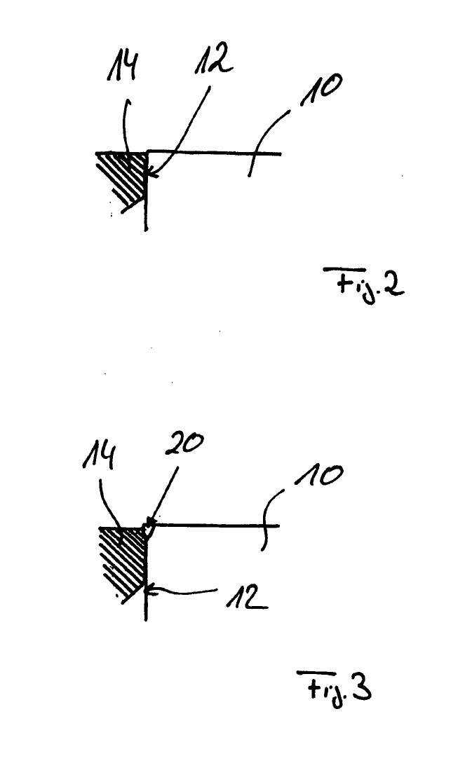

As illustrated in FIG. 1, the opposing ends of both cooling jaws 14 and 15 are fastened on a crossbeam by bolts 19 in a slidable manner in order to adapt the spacing of the two cooling jaws 14 and 15 to the dimension of blade stump 10. As FIG. 1 illustrates, blade stump 10 is clamped with it flow leading edge 12 and its flow trailing edge 13 in a central region between the two cooling jaws 14 and 15. FIG. 2 is a cross-sectional view through detail II of FIG. 1 in the region of cooling jaw 14 and the flow leading edge 12 of blade stump 10.

After clamping blade stump 10 into cooling device 11, a punctiform welding bead 20 is applied by laser powder build-up welding both in the region of flow leading edge 12 as well as in the region of flow trailing edge 13. As illustrated in FIG. 3, welding bead 20 protrudes with respect to flow leading edge 12 as well as with respect to flow trailing edge 13 such that in this region an excess or allowance is held in reserve. The region between flow leading edge 12 and cooling jaw 14 as well as between flow trailing edge 13 and cooling jaw 14 is bridged so to speak by the respective welding bead 20, welding bead 20 bonding only to blade stump 10 on account of the different material compositions.

Following the application of welding beads 20, material is then applied by laser powder build-up welding between the welding beads in order to restore the removed blade section of the gas turbine blade to be repaired. The laser powder build-up welding for restoring the removed blade section between the previously applied welding beads 20 may be done, for example, as described in U.S. Pat. No. 6,172,327. Since the details of laser powder build-up welding should be familiar to persons skilled in the art, they do not require more elaborate explanation at this point.

During the application of welding beads 20 and during the subsequent application of additional material between welding beads 20 for restoring the removed blade section, cooling device 11 and thus flow leading edge 12 and flow trailing edge 13 of the blade stump are actively cooled in that cooling medium flows through cooling jaws 14 and 15 of cooling device 11. This prevents damaging the blade in the region of the sensitive flow leading edge and flow trailing edge.

Following the restoration of the removed blade section by laser powder build-up welding, an allowance exists in the region of the flow leading edge and the flow trailing edge. This can then be removed by a removal process, for example, by a cutting or electrochemical reworking in order to provide fluidic final contours in the region of the flow leading edge and the flow trailing edge.

The method addresses the issue of applying or bonding the first powder layer onto the blade stump, on the one hand, by first applying, prior to the actual laser powder build-up welding, welding beads in the region of the flow leading edge and the flow trailing edge by laser powder build-up welding, cooling being performed during this process as well as during the actual laser powder build-up welding. Using the method, a perfect bonding of the critical first powder layer may be achieved without damaging the delicate flow leading edges and flow trailing edges.

1-7. (canceled)

8. A method for repairing a turbo machine blade, comprising:
a) providing at least one of (a) a turbo machine blade to be repaired and (b) an integrally bladed rotor to be repaired having a damaged blade section;
b) removing the damaged blade section from the at least one of (a) the turbo machine blade and (b) the integrally bladed rotor, resulting in a blade stump;
c) clamping the blade stump at least in a region of a flow leading edge and a flow trailing edge of a same in a cooling device;
d) applying respectively a punctiform welding bead in the region of the flow leading edge and the flow trailing edge of the blade stump by laser powder build-up welding, the welding beads protruding at least over the flow leading edge and the flow trailing edge;
e) applying material by laser powder build-up welding between the welding beads in the region of the removed blade section to restore the respective blade section.

9. The method according to claim 8, wherein the turbo machine blade includes a gas turbine machine blade on an integrally bladed gas turbine rotor.

10. The method according to claim 8, wherein the blade stump is clamped in the cooling device such that the cooling device encloses the blade stump.

11. The method according to claim 8, further comprising actively cooling the cooling device the laser powder build-up welding.

12. The method according to claim 11, wherein a cooling medium flows through the cooling device during the actively cooling of the cooling device.

13. The method according to claim 12, further comprising, after the applying step e) removing material at least in the region of the flow leading edge and the flow trailing edge to provide fluidic final contours.
